(19) United States
(12) Patent Application Publication
(10) Pub. No.: US 2014/0201210 A1
(43) Pub. Date: Jul. 17, 2014

(54) AUTOMATIC MODEL SELECTION FOR ASSISTANCE DATA GENERATION BASED ON APRIORI INFORMATION

(71) Applicant: QUALCOMM INCORPORATED, San Diego, CA (US)

(72) Inventors: Rupali T. Desai, Pune (IN); Saumitra Mohan Das, Santa Clara, CA (US); Chandrakant Mehta, Santa Clara, CA (US); Abhinav Sharma, Santa Clara, CA (US)

(73) Assignee: QUALCOMM INCORPORATED, San Diego, CA (US)

(21) Appl. No.: 13/740,957

(22) Filed: Jan. 14, 2013

(51) Int. Cl. G06F 17/30

(52) U.S. Cl. CPC G06F 17/30598
USPC 707/740

(57) ABSTRACT

Various embodiments are described herein for improving relevancy and accuracy of assistance data (AD) generation from a set of floor plan map data based on contextualizing parameters in the set of floor plan map data to other related floor plan maps. The relevancy and accuracy of assistance data derived from a floor plan map may be improved by contextualizing or matching the floor plan map to other related floor plan maps where associated assistance data is already recorded. In some embodiments, floor plan maps may be identified which are closely related to the new floor plan map to be analyzed, and then the measurements of the closely related floor plan map as assistance data for the new floor plan map may be reused. In some embodiments, a relationship tree graph may be used to organize the floor plan maps into a logical relationship between each other.

### BACKGROUND

Indoor positioning techniques may rely on information about properties or parameters of a floor plan in order to accurately determine a position of user or mobile device on that floor. Indoor positioning techniques may use access points (APs) located on or near the floor to determine timing or distance information to the user or mobile device. To improve the accuracy of such readings, assistance data (AD) may be generated to specially adjust or account for unique characteristics about the floor the user is on. Traditional techniques for generating the AD may be cumbersome and potentially inaccurate, often times based on manually entering characteristics about the floor plan to generate the AD. It may therefore be desirable to implement efficient and streamlined methods for generating AD of floor plans.

### SUMMARY

These problems and others may be solved according to embodiments of the present invention, described herein.

Various embodiments are described herein for improving relevancy and accuracy of assistance data (AD) generation from a set of floor plan map data based on contextualizing parameters in the set of floor plan map data to other related floor plan maps. Indoor positioning techniques may rely on assistance data derived from floor plan maps to improve accuracy and speed in performing position/location operations. The relevancy and accuracy of assistance data derived from a floor plan map may be improved by contextualizing or matching the floor plan map to other related floor plan maps where associated assistance data is already recorded. In some embodiments, floor plan maps may be identified which are closely related to the new floor plan map to be analyzed, and then the measurements of the closely related floor plan map as assistance data for the new floor plan map may be reused. The measurements of the closely related floor plan may be used to derive certain signal propagation parameters that can be reused to generate assistance data on the current floor map.

In some embodiments, a new floor plan map may be identified having a first descriptive metric describing at least one characteristic of the new floor plan map. The new floor plan map may lack information of a first assistance data parameter associated with the new floor plan map. In some embodiments, the first assistance data parameter may be any one of a location of an access point, a heatmap signature of an access point, model parameters to generate a heatmap of an access point, an average thickness of walls on a floor plan map, an average density of walls on a floor plan map, or a geographic location of a floor plan map. A recorded floor plan map may then be identified having a second descriptive metric describing at least one characteristic of the recorded floor plan map. The second descriptive metric may relate to the first descriptive metric of the new floor plan map. A second assistance data parameter associated with the recorded floor plan map may be determined, based on identifying a category of the second assistance data parameter that matches a category of the lacking information of the first assistance data parameter associated with the new floor plan map. The information of the second assistance data parameter may then be recorded in the first assistance data parameter that was originally lacking information.

In some embodiments, the new floor plan map may be recorded in a hierarchal relationship tree structure at a position in the hierarchal relationship tree structure based on the first descriptive metric. The hierarchal relationship tree structure may include a plurality of floor plan maps including the recorded floor plan map. The plurality of floor plan maps may be organized according to a descriptive metric for each of the plurality of floor plan maps.

In some embodiments, identifying the recorded floor plan map may include identifying a floor plan map within the plurality of floor plan maps that both contains information in the category of the lacking information associated with the new floor plan map, and is determined to be nearest in relationship to the new floor plan map. Determining the nearest relationship to the new floor plan map may be based on comparing the first descriptive metric of the new floor plan map with the second descriptive metric of the recorded floor plan map.

In some embodiments, recording the information of the first assistance data parameter that was lacking may include determining an average value among matching assistance data parameters of at least some of the plurality of floor plan maps in the hierarchal relationship tree structure. Also, the average value among the matching assistance data parameters may be recorded as the lacking information of the first assistance data parameter. In other embodiments, a most common value among matching assistance data parameters of at least some of the plurality of floor plan maps in the hierarchal relationship tree structure may be determined. The common value among the matching assistance data parameters may be recorded as the lacking information of the first assistance data parameter.

In some embodiments, a third assistance data parameter associated with the new floor plan map may be identified. The third assistance data parameter may include information related to the first assistance data parameter that lacks information. Recording information of the first assistance data parameter that was lacking may then be based on information of the third assistance data parameter associated with the new floor plan map.

### BRIEF DESCRIPTION OF THE DRAWINGS

A further understanding of the nature and advantages of various embodiments may be realized by reference to the following figures. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 is an example multiple access wireless communication system according to some embodiments.

FIG. 2 is an example wireless communications interface including a transmitter system and a receiver system according to some embodiments.

FIGS. 3A and 3B are example floor plan maps whose assistance data parameters may be improved according to some embodiments.

FIG. 4 is an example flowchart illustrating high-level motivations of embodiments of the present invention.

FIGS. 5A and 5B are example hierarchal relationship tree structures according to some embodiments.

FIGS. 6A and 6B are example flowcharts according to some embodiments.

FIG. 7 is an example computer system according to some embodiments.

### DETAILED DESCRIPTION

The word “exemplary” is used herein to mean “serving as an example, instance, or illustration.” Any embodiment or design described herein as “exemplary” is not necessarily to be construed as preferred or advantageous over other embodiments or designs.

As used herein, an “access point” may refer to any device capable of and/or configured to route, connect, share, and/or otherwise provide a network connection to one or more other devices. An access point may include one or more wired and/or wireless interfaces, such as one or more Ethernet interfaces and/or one or more IEEE 802.11 interfaces, respectively, via which such a connection may be provided. For example, an access point, such as a wireless router, may include one or more Ethernet ports to connect to a local modem or other network components (e.g., switches, gateways, etc.) and/or to connect to one or more other devices to which network access is to be provided, as well as one or more antennas and/or wireless networking cards to broadcast, transmit, and/or otherwise provide one or more wireless signals to facilitate connectivity with one or more other devices. Other examples of access points may include a femto cell or wireless beacon.

Various embodiments are described herein in connection with an access terminal. An access terminal can also be called a system, subscriber unit, subscriber station, mobile station, mobile, remote station, remote terminal, mobile device, user terminal, terminal, wireless communication device, user agent, user device, or user equipment (UE). An access terminal can be a cellular telephone, a cordless telephone, a Session Initiation Protocol (SIP) phone, a wireless local loop (WLL) station, a personal digital assistant (PDA), a handheld device having wireless connection capability, computing device, or other processing device connected to a wireless modem.

Various embodiments are described herein for improving relevancy and accuracy of assistance data (AD) generation from a set of floor plan map data based on contextualizing parameters in the set of floor plan map data to other related floor plan maps. Indoor positioning techniques may rely on assistance data derived from floor plan maps to improve accuracy and speed in performing position/location operations. Examples of assistance data may include locations of access points on a floor plan map, heatmap signatures of each access point on different regions of the floor plan map, heatmap signatures of different types of signal characteristics of the access points (e.g. RSSI and RTT), average thickness/density of walls on the floor plan map, a location of the floor plan map expressed in latitude/longitude, etc. Current techniques for generating such assistance data for a new floor plan map may involve cumbersome manual procedures to enter traits about the new floor plan map. In other cases, current techniques may simply use generic values for each new floor plan map in place of specific assistance data. Thus, relying on traditional techniques, that either manually specify this assistance data or rely on merely generic values, may not be as desirable when obtaining and utilizing assistance is to be performed for many floor plan maps, e.g. hundreds or thousands.

However, in some embodiments, the relevancy and accuracy of assistance data (AD) derived from a floor plan map may be improved by contextualizing or matching the floor plan map to other related floor plan maps where associated assistance data is already recorded and good practice parameters associated with assistance data generation are already obtained. In some embodiments, floor plan maps may be identified which are closely related to the new floor plan map to be analyzed, and then the model parameters values derived from measurements (e.g. via survey or crowdsourcing) done on the closely related floor plan map as assistance data for the new floor plan map may be reused.

In some cases, data indicative of new floor plan maps may be annotated with descriptive information or metrics such as “in same building as floor plan map X,” or “in same complex as floor plan map Y,” etc. These comments may then suggest strongly that the assistance data of the floor plan map “in the same building” or “in the same complex” can be reused for annotating the new floor plan map. In other cases, AD generation for new floor plan maps may be determined by taking an average value of the AD parameters in question for the known area of the new floor plan map. In other cases, the most common value of that AD parameter in the area may be used.

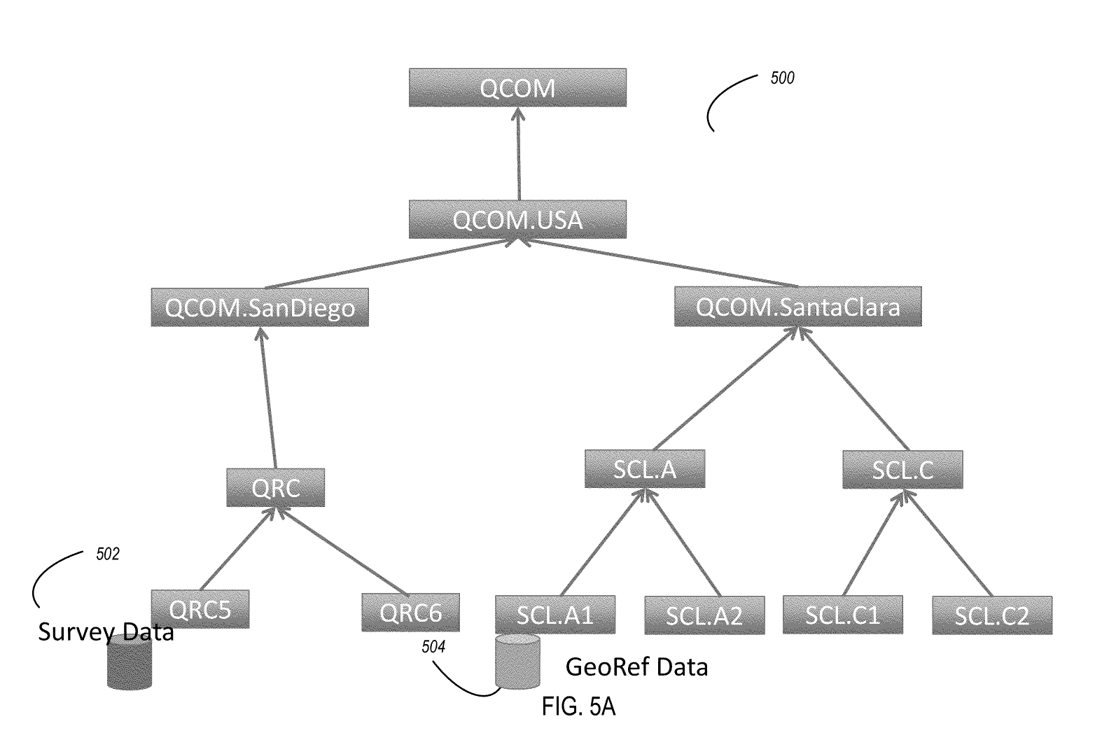

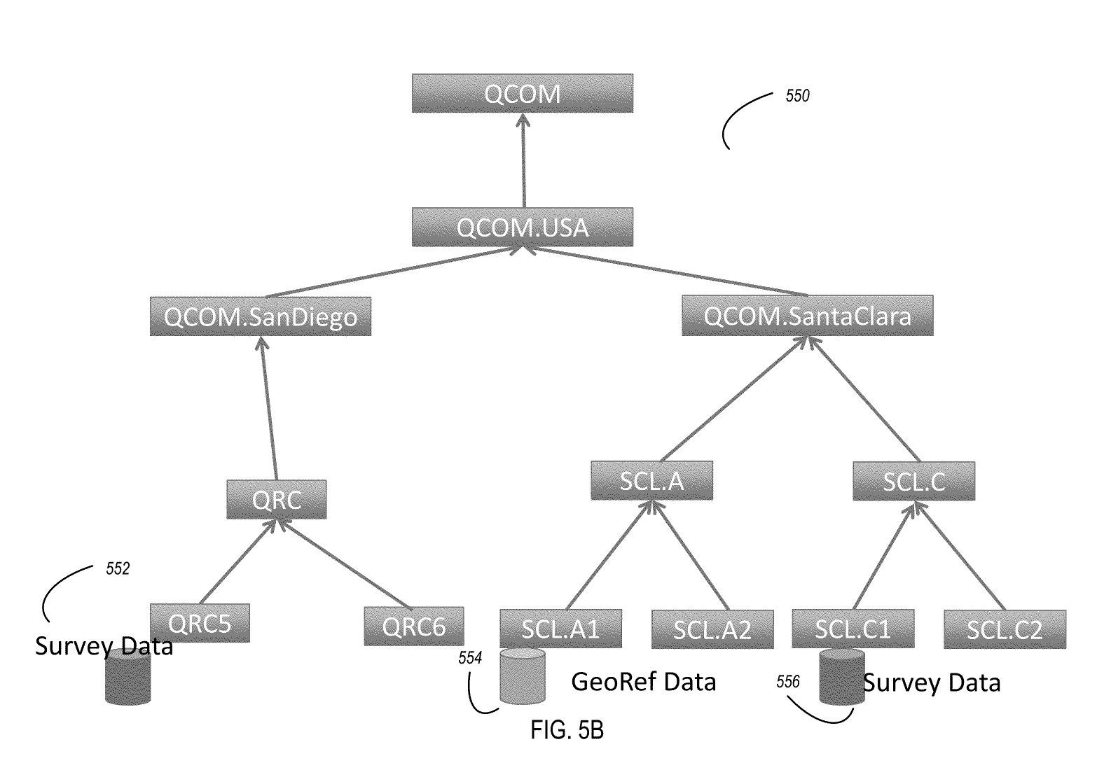

In some aspects, a relationship tree or graph may be used to describe how floor plan maps may be related to the new floor plan map to be analyzed. Such a relationship tree may be described in FIGS. 5A and 5B, below.

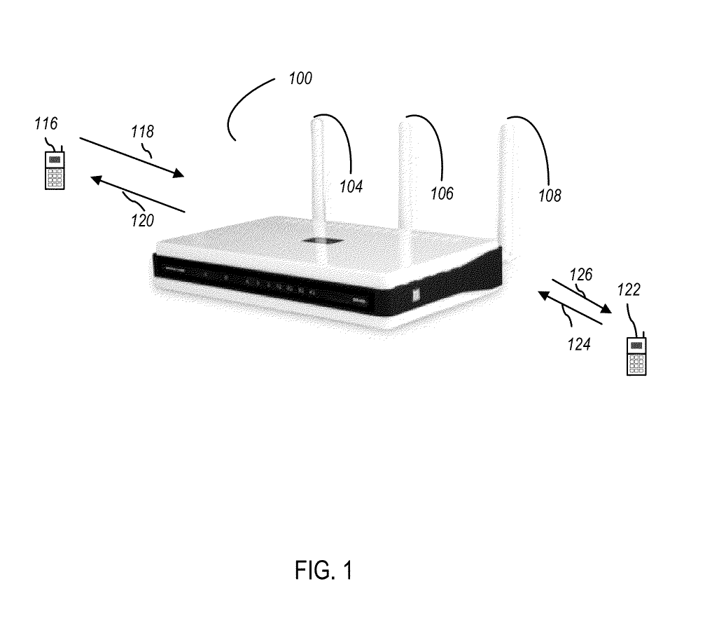

Referring to FIG. 1, an example multiple-access access point utilized in some embodiments is presented. Access point (AP) 100 includes multiple antennas, including 104, 106, and 108. More or fewer antennas may be utilized in other embodiments. Access terminal 116 (AT) may be in communication with AP 100 via antenna 104, where antenna 104 may transmit signals to access terminal 116 over forward link 120 and may receive signals from access terminal 116 over reverse link 118. Access terminal 122 is in communication with AP 100 via antenna 108, where antenna 108 may transmit signals to access terminal 122 over forward link 126 and may receive signals from access terminal 122 over reverse link 124. In a Frequency Division Duplex (FDD) system, communication links 118, 120, 124 and 126 may use different frequencies for communication. For example, forward link 120 may use a different frequency then that used by reverse link 118. In some embodiments, antennas 104, 106, and 108 may each be in communication with both ATs 116 and 122. AT 116 may be in communication with AP 100 in a first frequency, while AT 122 may be in communication with AP 100 in a second frequency, for example. In some embodiments, multiple antennas, e.g. antennas 104 and 106, may be in communication with just a single mobile device, e.g. AT 116. Multiple antennas may be used to transmit the same type of data but arranged in different sequences to improve diversity gain.

Each group of antennas and/or the area in which they are designed to communicate is often referred to as a sector of the access point. In some embodiments, antenna groups each are designed to communicate to access terminals in a sector of the areas covered by access point 100.

In communication over forward links 120 and 126, the transmitting antennas of access point 100 may utilize beamforming in order to improve the signal-to-noise ratio of forward links for the different access terminals 116 and 124. Also, an access point using beamforming to transmit to access terminals scattered randomly through its coverage causes less interference to access terminals in neighboring cells than an access point transmitting through a single antenna to all its access terminals.

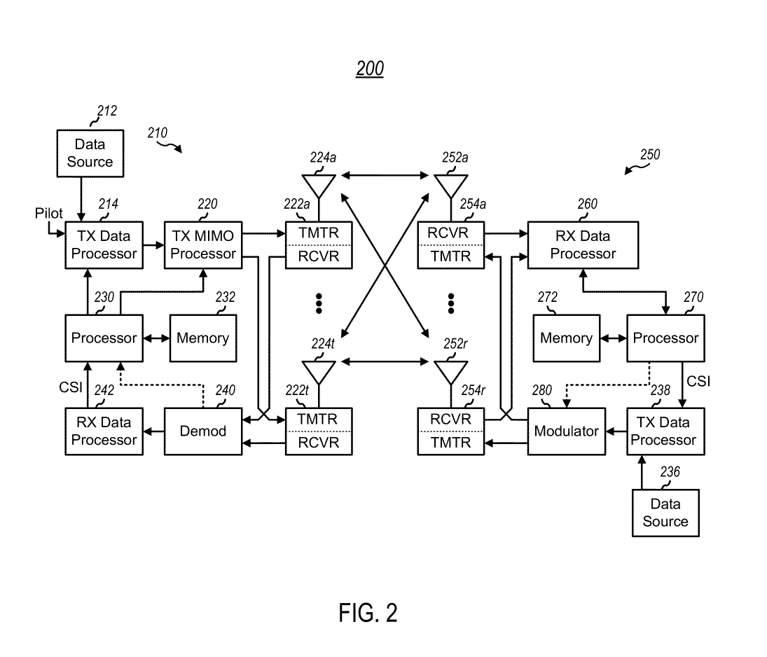

FIG. 2 is a block diagram of an embodiment of a transmitter system 210 of an access point and a receiver system 250 of an access terminal in a multiple-input and multiple-output (MIMO) system 200 according to some embodiments. At the transmitter system 210, traffic data for a number of data streams is provided from a data source 212 to a transmit (TX) data processor 214.

In some embodiments, each data stream is transmitted over a respective transmit antenna. TX data processor 214 formats, codes, and interleaves the traffic data for each data stream based on a particular coding scheme selected for that data stream to provide coded data.

The coded data for each data stream may be multiplexed with pilot data using orthogonal frequency division multiplexing (OFDM) techniques. The pilot data is typically a known data pattern that is processed in a known manner and may be used at the receiver system to estimate the channel response. The multiplexed pilot and coded data for each data stream is then modulated (i.e., symbol mapped) based on a particular modulation scheme (e.g., BPSK, QSPK, M-PSK, or M-QAM) selected for that data stream to provide modulation symbols. The data rate, coding, and modulation for each data stream may be determined by instructions performed by processor 230.

The modulation symbols for all data streams are then provided to a TX MIMO processor 220, which may further process the modulation symbols (e.g., for OFDM). TX MIMO processor 220 then provides NT modulation symbol streams to NT transmitters (TMTR) 222a through 222t, where NT is a positive integer associated with transmitters described in FIG. 2. In certain embodiments, TX MIMO processor 220 applies beamforming weights to the symbols of the data streams and to the antenna from which the symbol is being transmitted.

Each transmitter 222 receives and processes a respective symbol stream to provide one or more analog signals, and further conditions (e.g., amplifies, filters, and upconverts) the analog signals to provide a modulated signal suitable for transmission over the MIMO channel. NT modulated signals from transmitters 222a through 222t are then transmitted from NT antennas 224a through 224t, respectively.

At receiver system 250, the transmitted modulated signals are received by NR antennas 252a through 252r and the received signal from each antenna 252 is provided to a respective receiver (RCVR) 254a through 254r, where NR is a positive integer associated with receivers described in FIG. 2. Each receiver 254 conditions (e.g., filters, amplifies, and downconverts) a respective received signal, digitizes the conditioned signal to provide samples, and further processes the samples to provide a corresponding “received” symbol stream.

An RX data processor 260 then receives and processes the NR received symbol streams from NR receivers 254 based on a particular receiver processing technique to provide NT “detected” symbol streams. The RX data processor 260 then demodulates, deinterleaves, and decodes each detected symbol stream to recover the traffic data for the data stream. The processing by RX data processor 260 is complementary to that performed by TX MIMO processor 220 and TX data processor 214 at transmitter system 210.

A processor 270 periodically determines which pre-coding matrix to use (discussed below). Processor 270 formulates a reverse link message comprising a matrix index portion and a rank value portion. Memory 272 stores the various pre-coding matrices that are used by processor 270.

The reverse link message may comprise various types of information regarding the communication link and/or the received data stream. The reverse link message is then processed by a TX data processor 238, which also receives traffic data for a number of data streams from a data source 236, modulated by a modulator 280, conditioned by transmitters 254a through 254r, and transmitted back to transmitter system 210.

At transmitter system 210, the modulated signals from receiver system 250 are received by antennas 224, conditioned by receivers 222, demodulated by a demodulator 240, and processed by a RX data processor 242 to extract the reserve link message transmitted by the receiver system 250. Processor 230 then determines which pre-coding matrix to use for determining the beamforming weights then processes the extracted message. Processor 230 obtains the pre-coding matrices from memory 232, which stores various pre-coding matrices. Memory 232 may also contain other types of data, such as information databases and locally and globally unique attributes of multiple base stations.

The techniques described herein may also be practiced with APs containing just a single receiving antenna and a single transmitting antenna (SISO), a single receiving antenna and multiple transmitting antennas (SIMO), and multiple transmitting antennas and a single receiving antenna (MISO) with configurations similar to those described in FIGS. 1 and 2. Embodiments are not so limited.

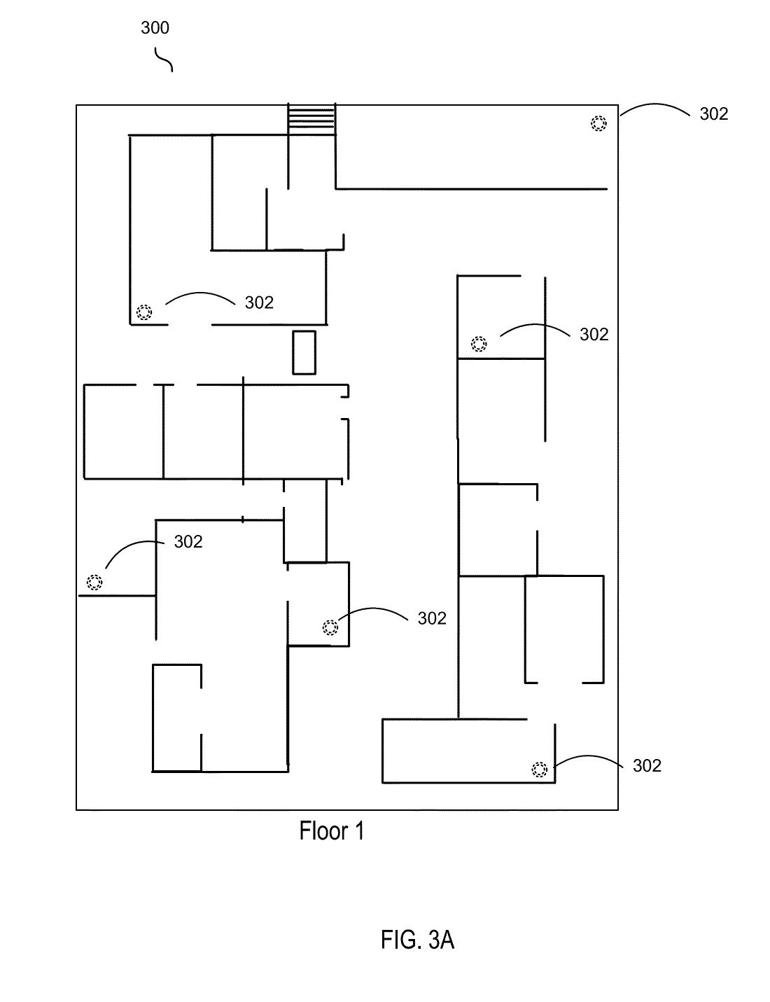

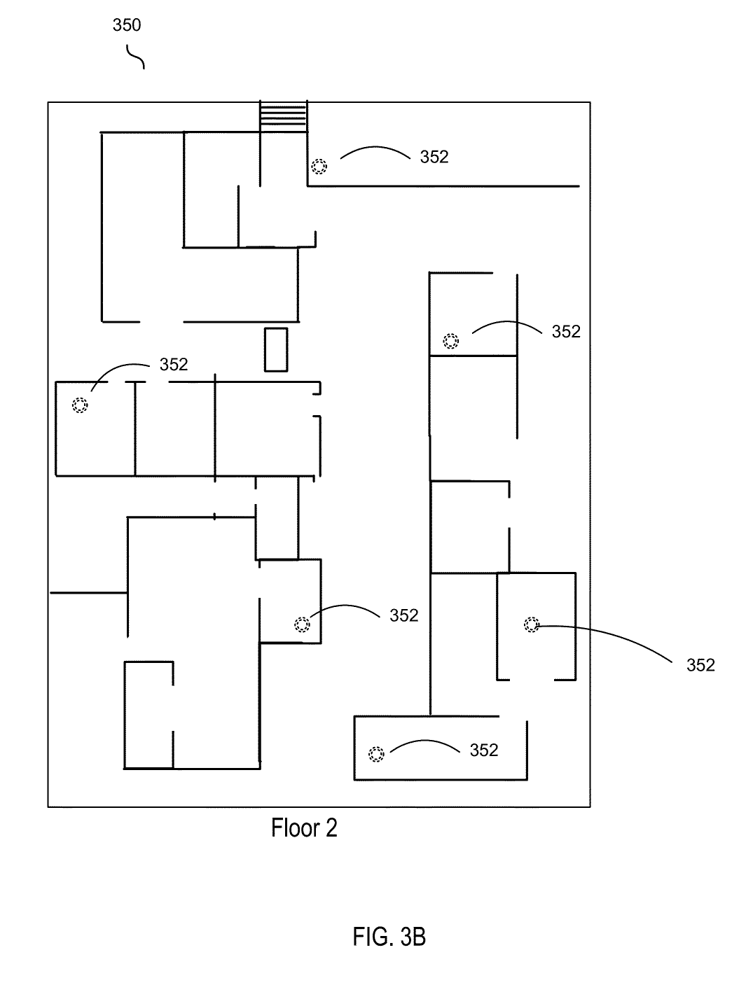

Referring to FIG. 3A, exemplary floor plan map 300 may illustrate an example placement of numerous APs onto a single floor plan. Floor plan map 300 in FIG. 3A may represent a first floor of an office building or a mall, for example. APs 302 may be placed at various locations around floor plan map 300, as shown. To optimize indoor positioning calculations using the APs 302, various parameters about the APs and the floor plan may be obtained and provided to a mobile device as assistance data (AD). For example, the strength of the APs 302 may be provided, expressed as a heatmap signature. As another example, the physical layout of the floor plan 300 may be provided. Additionally, the thickness of the walls may be specified, and the make and model of the APs may be provided. Also the area type may be enumerated such as whether the area is an open space, corridor or contains cubicles. These parameters may be obtained by the venue owner of the floor 300, and alternatively may be obtained by crowd sourcing methods, or other types of methods known in the art.

Referring to FIG. 3B, exemplary floor plan map 350 may illustrate an example placement of numerous APs of a second floor plan map, related to floor plan map 300, but where the AD of floor plan map 350 is not yet obtained. Here, floor plan map 350 in FIG. 3B may represent a second floor of the same office building or mall associated with floor plan map 300 in FIG. 3A. In this example, the physical layout of the floor plan map 350, e.g. the locations of the walls, doors, and stairs, appears to be exactly the same as in floor plan map 300. However, the locations of the APs 352 may be slightly different than the locations of the APs 302 in floor plan map 300. Such a scenario may not be uncommon for different floors of the same building, as construction designs of buildings tend to have floor plans that look similar if not exactly alike. As briefly mentioned, AD may not yet be obtained for floor plan map 350. In other words, parameters specifying the locations of the APs 352, the locations of the walls, doors, stairs of floor plan map 350, the thickness of the walls, the type of materials used in making floor plan map 350, the make and model of the APs 352, heatmap model parameters, etc., may not yet be obtained, for whatever reasons. Of course, it may be desirable to take accurate measurements for all of these parameters in order to obtain the most precise and accurate AD for use in floor plan map 350. However, time restrictions and other restrictions may preclude such detailed work from occurring.

Instead, in some embodiments, AD not known for a floor plan map, e.g. floor plan map 350, may be obtained by relying on AD known from a related floor plan map, e.g. floor plan map 300. Such reliance on a related floor plan map may be accurate and convenient because floor plan maps 300 and 350 may be similar, if not identical, in their layouts, construction, etc. For example, it is clear in this case that the locations of the walls, doors and stairs of floor plan maps 300 and 350 are the same. It may also be likely that the materials used to build both floors are the same. If the APs are provided by the a common owner, then the make and models of the APs may be the same. In this case, it is clear that the locations of the APs are not exactly the same, relative to their locations on each floor. Nevertheless, the heatmap model parameters of the related floor plan map may still be accurate and reusable for the unknown floor plan map. Heatmap model parameters may include the general heatmap signature of some or all of the floor plan map, and any data related to illustrating the signal strength of any particular location on the floor plan map. For example, a signal strength (heatmap) model of an example AP 1 at a point (x,y) on a floor plan map may be expressed as: alpha*(direct distance from x,y to AP1)+beta*(routing distance from x,y, to AP1)+gamma*(num wall crossings between x,y, and AP1)+omega. In this example, alpha, beta, gamma and omega may be example heatmap model parameters that may be obtained from one floor plan map and reused in another related floor plan map. In some embodiments, these parameters may be optimized in one floor plan map and then reused on other floor plan maps.

By comparison, generating AD for a floor plan map using simply generic parameters may be far less accurate or reliable. For example, generic AD parameters may provide just one possible type of data for each AD parameter, e.g. one make and model of APs, one layout of heatmap signature for any AP, one measurement of wall thickness, etc. While generic AD may provide somewhat of an approximation to the actual, correct parameters of the floor plan map, it would be desirable to generate AD that is at least a better approximation, based on more reasonable estimations.

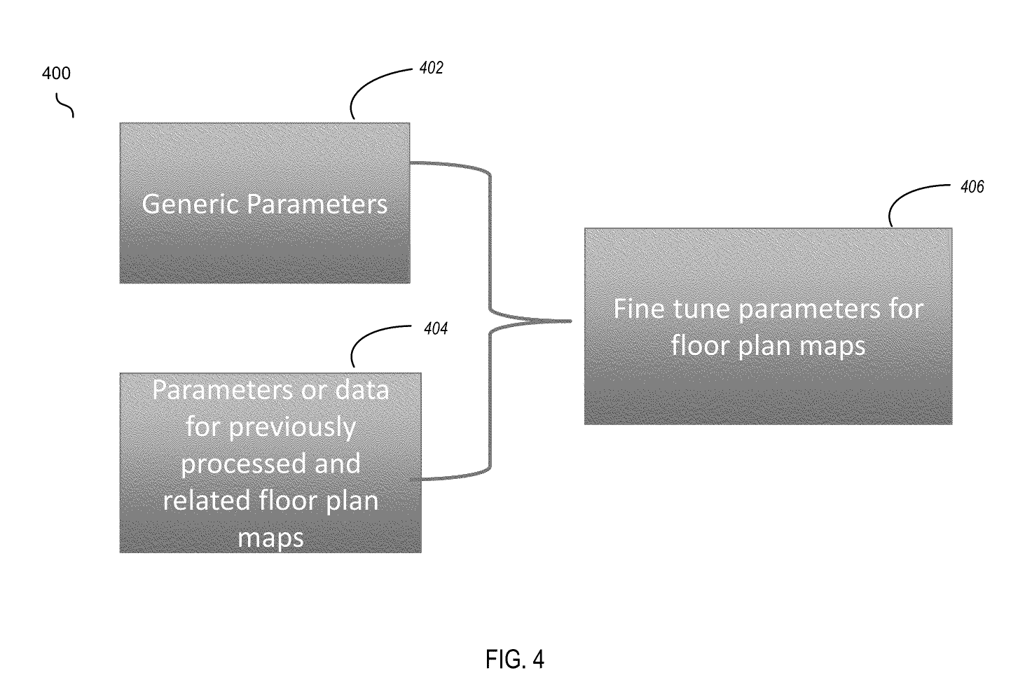

Referring to FIG. 4, chart 400 illustrates a general principle to be achieved by embodiments of the present invention. Specifically, in some embodiments, generic AD parameters of a floor plan map 402 may be combined with parameters from previously processed and related floor plan maps 404 in order to fine tune AD parameters for floor plan maps 406. The result may be a better approximation to AD parameters for floor plan maps that may better assist in performing indoor positioning calculations and other procedures that utilize APs. Again, the AD parameters of previously processed and related floor plan maps may be advantageous to use because there may be related properties about the previously processed floor plan map(s) and the new floor plan map in question. Some examples of what types of AD parameters may be similar, if not exact, are described in reference to FIGS. 3A and 3B, but other types of parameters may be apparent to those of ordinary skill in the art, and embodiments are not so limited.

Referring to FIG. 5A, in some embodiments, a relationship graph “tree” 500 linking related floor plan maps together may be used to more intelligently identify which related floor plan maps may be used to best approximate the AD parameters of a new floor plan map. In this example, the lowest level of the graph 500 may represent a floor plan map entry, e.g. “SCL.A1,” “QRC5,” etc. For example, “SCL.A1” may represent a floor plan map of floor 1 of building A at campus location SCL. Similarly, “SCL.A2” may represent a floor plan map of floor 2 of building A at campus location SCL. The levels above the lowest level may represent progressively broader levels of detail describing the location and general information about each floor plan map. For example, “QRC” and “SCL.A” may represent the name of buildings, while “QCOM.SanDiego” and “QCOM.SantaClara” may represent the name of campuses housing such buildings. “QCOM.USA” may represent the larger region containing such campuses, and “QCOM” may represent the overall company containing such a region. Each block in the relationship graph 500 may contain survey data 502 and/or geo-reference data 504. Survey data 502 may contain information about the physical structures of the floor plan map, such as measurements of wall thickness, physical layout, and the like. Geo-reference data may contain positioning data of the floor plan map itself, as well as positioning data of any of the APs within the floor plan map. Some blocks in the relationship graph 500 may contain both types of data 502 and 504; some may contain only one type, and some may contain none at all. In other cases, only partial sets of information of either type of data 502 or 504 may be present, and embodiments are not so limited.

The relationship graph may be generated with a plurality of floor plan maps accurately placed based on annotations or other types of information describing or suggesting relationships between the various floor plan maps. For example, some floor plan maps may have descriptions or annotations that read, “in same building,” “in same complex,” “in same organization,” in same venue function,” “in same city,” etc., as at least one other floor plan map. These types of annotations may be used to place the floor plan maps under appropriate hierarchal layers of the relationship graph. In other cases, floor plan maps may have less descriptive names or titles, but may at least be cryptically named in ways that are similar to names or titles of other floor plan maps. In general, any types of intelligible information may be used to determine a best estimate of where the floor plan maps ought to be placed within the relationship graph, and embodiments are not so limited.

Still referring to FIG. 5A, in some embodiments, the relationship graph 500 may help improve AD parameter generation of a floor plan map missing at least one AD parameter as follows. By way of example, suppose “SCL.A2” is a new floor plan map to be analyzed, meaning “SCL.A2” lacks at least some AD parameters and this information needs to be determined. Then, in some embodiments, the AD from the “closest relationship” to “SCL.A2” with known parameters may be used to help fine-tune the AD of “SCL.A2,” which has some unknown parameters. The closest relationship may be determined by traversing the relationship graph 500, starting from the new floor plan map in question, in this case “SCL.A2.” One example traversal may be to first identify whether any floor plan maps under the same “parent” category as “SCL.A2” contain the lacking AD parameter(s). In this case, it is floor plan map “SCL.Al” which is under common parent category “SCL.A.” If this floor plan map does not contain sufficient information, then the traversal may continue up the relationship graph and back down again until the next-closest related floor plan map may be identified. Here, by following the connections in the relationship graph, the next closest floor plan maps appear to be “SCL.C1” and “SCL.C2.” If this information is also lacking, then the traversal may continue in a similar fashion until the needed AD parameter(s) is obtained. Other traversal methods involving different orderings of traversals may be used, and embodiments are not so limited.

The order of traversal through the relationship graph 500 may be based on the concept that floor plan maps are more similar to one another the closer in relationship they are to one another. In other words, by way of examples, the floor plan maps within the same building may be most similar, and then floor plan maps of different buildings but within the same campus may be secondarily similar. Next, floor plan maps not within the same campus, but within the same general geographic region, for example, may be the next closest relationship. Finally, floor plan maps not even within the same geographic region but at least within the same company may be the next closest relationship. Other relationships, organized with other reasonably related hierarchies, may guide different traversals, and embodiments are not so limited. In general, organizing floor plan maps through some kind of relationship graph, and traversing the graph to find the closest related floor plan maps with known AD parameters, may rely on some reasonable relationships, some as illustrated by these examples.

Continuing with the present example, suppose “SCL.A2” lacks both survey data and geo-reference data. Suppose the only survey data that is available is the survey data 502 for floor plan map “QRC5.” Suppose the only geo-reference data available is the geo-reference data 504 for floor plan map “SCL.A1.” Thus, in some embodiments, the survey data 502 may be obtained for SCL.A2 by traversing through the relationship graph 500 to find the survey data 502 at “QRC5.” Also, the geo-reference data 504 may be obtained for SCL.A2 by traversing through the relationship graph 500 to find the geo-reference data 504 at “SCL.A1.”

Referring to FIG. 5B, a different scenario shown in relationship graph 550 may illustrate further how the graph traversal may operate in some embodiments. Suppose still that “SCL.A2” lacks both survey data and geo-reference data, and that the only survey data available is shown, i.e. survey data 552 at “QRC5,” and survey data 556 at “SCL.C1.” Also, suppose the only geo-reference data available is geo-reference data 554 at “SCL.A1.” Here, following an example traversal as described above, survey data 556 may be obtained as the closest-related survey data for “SCL.A2,” rather than survey data 552. Thus, the survey data from the closer-related floor plan map “SCL.C1” may be correctly determined to be used to fine-tune the AD parameters of “SCL.A2.”

In some embodiments, the relationship graph may contain even deeper or more detailed relationships than shown in FIGS. 5A and 5B. For example, sub-sections of particular floor plan maps may be compared against other related sub-sections of the same floor plan map. These relationships may be drawn as yet a lower level on the relationship tree, and relationships may be determined accordingly using similar methods as described herein.

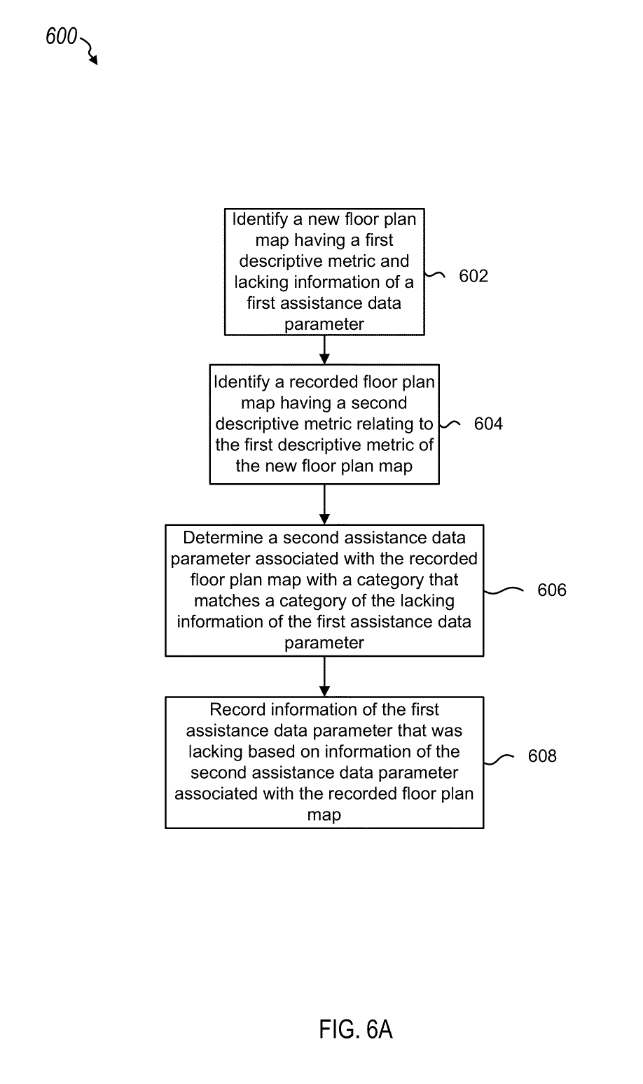

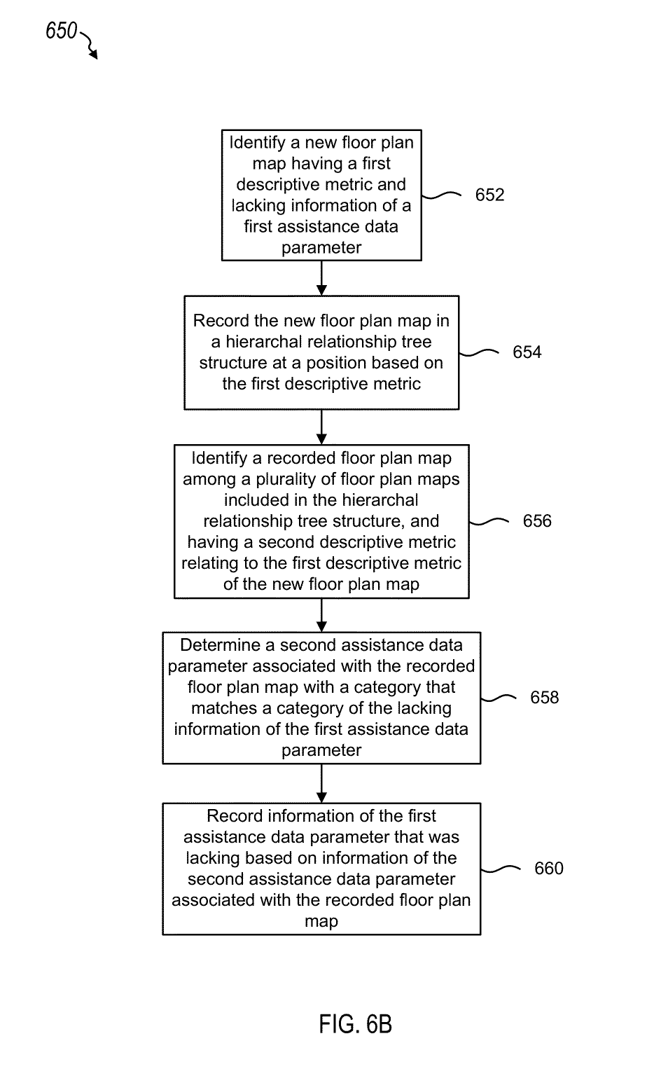

Referring to FIG. 6A, exemplary flowchart 600 may illustrate some method steps according to some embodiments. For example, at block 602, a method according to some embodiments may identify a new floor plan map having a first descriptive metric and lacking information of a first assistance data parameter. The first descriptive metric may describe at least one characteristic of the new floor plan map. An example of a first descriptive metric may include the name or title of the new floor plan map, which provides some descriptive context about the new floor plan map. For example, the new floor plan map may be named “SCL.A2,” which may provide some description about what campus the new floor plan map is located, what building of the campus the new floor plan map is in, and what floor of the building the new floor plan map is. Example categories of a first assistance data parameter that may be lacking in the new floor plan map may include locations of access points in the new floor plan map, heatmap signatures of the access points, information about the physical layout of the walls, doors, stairs, etc. of the new floor plan map, and geographic information of the new floor plan map. Further examples of assistance data parameters have been described throughout these disclosures, including at FIGS. 3A, 3B, 4, 5A, and 5B. In some embodiments, the new floor plan map may lack all or most information about each assistance data parameter that is typically recorded to assist with indoor positioning calculations and other similar procedures. In some embodiments, the new floor plan map may lack only one assistance data parameter or merely some information about some assistance data parameters.

At block 604, methods according to some embodiments may identify a recorded floor plan map having a second descriptive metric. The second descriptive metric may describe at least one characteristic of the recorded floor plan map, and may relate to the first descriptive metric of the new floor plan map. An example of a second descriptive metric may include the name or title of the recorded floor plan map, which provides some descriptive context about the recorded floor plan map. For example, the recorded floor plan map may be named “SCL.A1,” which may provide some description about what campus the recorded floor plan map is located, what building of the campus the recorded floor plan map is in, and what floor of the building the recorded floor plan map is. The second descriptive metric may relate to the first descriptive metric in that the descriptions of each may be similar, or at least have information that is common to both descriptive metrics. For example, in the case of “SCL.A1” and “SCL.A2,” the two descriptive metrics may relate to each other in that they both correspond to the same campus (e.g. SCL), and also to the same building (e.g. A). While in this case, the descriptive metrics include the names of the floor plan maps, other descriptive metrics may be used. For example, it may be known that both the new floor plan map and the recorded floor plan map have completely different names (e.g. “SCL.A2” and “QR5”), but still have related descriptive metrics in that both floor plan maps are located in the state of California. In some embodiments, the recorded floor plan map may include known assistance data parameters, e.g. information about the locations of APs in the recorded floor plan map may all be known, information about the physical layout of the recorded floor plan map may be known, and geographic information about the recorded floor plan map may be known. In other words, much or all of the AD parameters may already be recorded for the recorded floor plan map.

At block 606, a method according to some embodiments may determine a second assistance data parameter associated with the recorded floor plan map with a category that matches a category of the lacking information of the first assistance data parameter. For example, if the category of the first assistance data parameter, “average wall thickness” is lacking information in the new floor plan map, this same category among the assistance data parameters of the recorded floor plan map may be determined, and the information in “average wall thickness” in the recorded floor plan map may be obtained.

At block 608, a method according to some embodiments may record information of the first assistance data parameter that was lacking based on information of the second assistance data parameter associated with the recorded floor plan map. For example, the information about the “average wall thickness” assistance data parameter in the recorded floor plan map may now be recorded as the “average wall thickness” assistance data parameter in the new floor plan map, for this information was lacking in the new floor plan map. The information of the second assistance data parameter may be recorded as the information originally lacking in the first assistance data parameter due to the knowledge that the new floor plan map and the recorded floor plan map have related descriptive metrics of some kind Knowing that the two floor plan maps are related, it may be reasonable to record the information from the recorded floor plan map into information for the new floor plan map. Example methodologies illustrating these steps are discussed at least in FIGS. 3A, 3B, 4, 5A and 5B.

Referring to FIG. 6B, exemplary flowchart 650 may illustrate some method steps according to other embodiments. Like in flowchart 600, at block 652, methods according to some embodiments may identify a new floor plan map having a first descriptive metric and lacking information of a first assistance data parameter. The descriptions of block 602 may be consistent with the descriptions of block 652 herein.

At block 654, a difference between flowchart 650 and flowchart 600 may be that, here, the new floor plan map may be recorded in a hierarchal relationship tree structure at a position based on the first descriptive metric. Examples of the hierarchal relationship tree structure may include those descriptions in FIGS. 5A and 5B. That is, the relationship tree structure may include a plurality of floor plan maps, where the floor plan maps may be organized according to at least one descriptive metric of each of the plurality of floor plan maps. The plurality of floor plan maps in the hierarchal relationship tree structure may already include the recorded floor plan map.

At block 656, the recorded floor plan map may be identified among the plurality of floor plan maps included in the hierarchal relationship tree structure. The recorded floor plan map, like that which is explained in flowchart 600, may have a second descriptive metric relating to the first descriptive metric of the new floor plan map. The relationship between the first and second descriptive metric may be consistent with the descriptions in block 604 of flowchart 600, as well FIGS. 3A, 3B, 4, 5A, and 5B. In some embodiments, the recorded floor plan map may be identified if the floor plan map contains information in the same category that is lacking information in the new floor plan map, and is also determined to be the nearest in relationship to the new floor plan map. The term “nearest in relationship” may refer to the floor plan map that contains the lacking information of the new floor plan map and is identified first using a relationship traversal method, for example any of the traversal methods described in FIGS. 5A and 5B. In some embodiments, determining what floor plan map to be nearest in relationship to the new floor plan map generally may be based at least in part on comparing the first descriptive metric of the new floor plan map with the second descriptive metric of the recorded floor plan map, whatever that recorded floor plan map may be.

Blocks 658 and 660 may be similar to the methods described in blocks 606 and 608, respectively. In some embodiments, determining the second assistance data parameter associated with the recorded floor plan map may be based on the relationship of the recorded floor plan map to the new floor plan map according to the hierarchal relationship tree structure.

In some embodiments, recording the information of the first assistance data parameter that was lacking may include incorporating a plurality of values of matching assistance data parameters amongst a plurality of floor plan maps, rather than just recording the same value in the one recorded floor plan map. For example, in some embodiments, an average value among matching assistance data parameters of floor plan maps that contain the information lacking in the new floor plan map may be determined. That average value may be recorded into the new floor plan map as the information that was lacking. In other cases, a most common value among matching assistance data parameters of floor plan maps that contain the information lacking in the new floor plan map may be determined. That most common value may be recorded into the new floor plan map as the information that was lacking Other variants for recording the lacking information in the new floor plan map may be implemented that are apparent to those having skill in the art, and embodiments are not so limited.

In some embodiments, assistance data parameters lacking in a new floor plan map may be estimated or ascertained using other assistance data parameters associated with the new floor plan map that has known information. For example, one assistance data parameter that may be unknown in the new floor plan map relates to information of a central cubical area of the new floor plan map. However, assistance data parameter information about the cubicles on the periphery of the new floor plan map may be known. In this case, the information about the cubicles on the periphery may be used to estimate or ascertain the unknown information about the cubicles in the central area. It may be apparent that such a concept is analogous to many of the above methods described herein, related to recording the lacking information of the new floor plan map based on assistance data parameters of related floor plan maps.

In these cases, the relationship graph may contain a sub-level below the floor plan map level, where sub-sections of the floor plan maps may be listed as blocks with names or titles similar to those shown in FIGS. 5A and 5B. Similar principles of relating information to unknown AD parameters, including methods for traversal and methods for utilizing the relationship graph, may apply, and embodiments are not so limited.

Many embodiments may be made in accordance with specific requirements. For example, customized hardware might also be used, and/or particular elements might be implemented in hardware, software (including portable software, such as applets, etc.), or both. Further, connection to other computing devices such as network input/output devices may be employed.

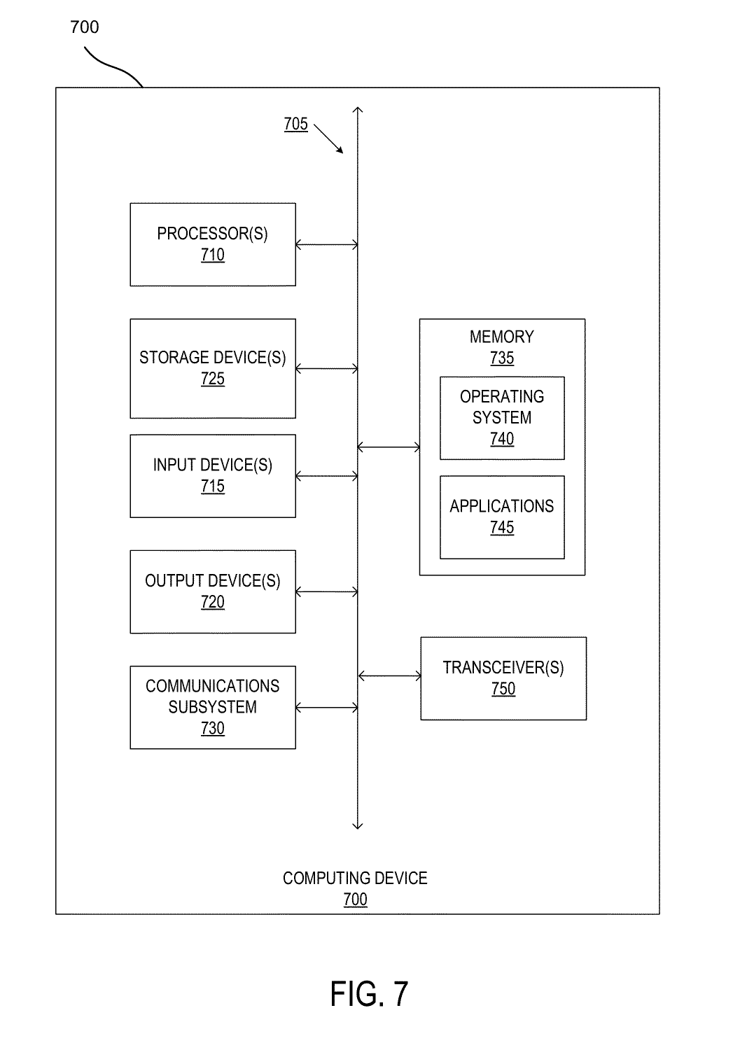

Having described multiple aspects of improving assistance data parameters in floor plan maps for indoor positioning, an example of a computing system in which various aspects of the disclosure may be implemented will now be described with respect to FIG. 7. According to one or more aspects, a computer system as illustrated in FIG. 7 may be incorporated as part of a computing device, which may implement, perform, and/or execute any and/or all of the features, methods, and/or method steps described herein. For example, computer system 700 may represent some of the components of a hand-held device. A hand-held device may be any computing device with an input sensory unit, such as a wireless receiver or modem. Examples of a hand-held device include but are not limited to video game consoles, tablets, smart phones, televisions, and mobile devices or mobile stations. In some embodiments, the system 700 is configured to implement any of the methods described above. FIG. 7 provides a schematic illustration of one embodiment of a computer system 700 that can perform the methods provided by various other embodiments, as described herein, and/or can function as the host computer system, a remote kiosk/terminal, a point-of-sale device, a mobile device, a set-top box, and/or a computer system. FIG. 7 is meant only to provide a generalized illustration of various components, any and/or all of which may be utilized as appropriate. FIG. 7, therefore, broadly illustrates how individual system elements may be implemented in a relatively separated or relatively more integrated manner.

The computer system 700 is shown comprising hardware elements that can be electrically coupled via a bus 705 (or may otherwise be in communication, as appropriate). The hardware elements may include one or more processors 710, including without limitation one or more general-purpose processors and/or one or more special-purpose processors (such as digital signal processing chips, graphics acceleration processors, and/or the like); one or more input devices 715, which can include without limitation a camera, wireless receivers, wireless sensors, a mouse, a keyboard and/or the like; and one or more output devices 720, which can include without limitation a display unit, a printer and/or the like. In some embodiments, the one or more processor 710 may be configured to perform a subset or all of the functions described above with respect to FIGS. 6A and 6B. The processor 710 may comprise a general processor and/or and application processor, for example. In some embodiments, the processor is integrated into an element that processes visual tracking device inputs and wireless sensor inputs.

The computer system 700 may further include (and/or be in communication with) one or more non-transitory storage devices 725, which can comprise, without limitation, local and/or network accessible storage, and/or can include, without limitation, a disk drive, a drive array, an optical storage device, a solid-state storage device such as a random access memory (“RAM”) and/or a read-only memory (“ROM”), which can be programmable, flash-updateable and/or the like. Such storage devices may be configured to implement any appropriate data storage, including without limitation, various file systems, database structures, and/or the like.

The computer system 700 might also include a communications subsystem 730, which can include without limitation a modem, a network card (wireless or wired), an infrared communication device, a wireless communication device and/or chipset (such as a Bluetooth® device, an 802.11 device, a WiFi device, a WiMax device, cellular communication facilities, etc.), and/or the like. The communications subsystem 730 may permit data to be exchanged with a network (such as the network described below, to name one example), other computer systems, and/or any other devices described herein. In many embodiments, the computer system 700 will further comprise a non-transitory working memory 735, which can include a RAM or ROM device, as described above. In some embodiments communications subsystem 730 may interface with transceiver(s) 750 configured to transmit and receive signals from access points or mobile devices. Some embodiments may include a separate receiver or receivers, and a separate transmitter or transmitters.

The computer system 700 also can comprise software elements, shown as being currently located within the working memory 735, including an operating system 740, device drivers, executable libraries, and/or other code, such as one or more application programs 745, which may comprise computer programs provided by various embodiments, and/or may be designed to implement methods, and/or configure systems, provided by other embodiments, as described herein. Merely by way of example, one or more procedures described with respect to the method(s) discussed above, for example as described with respect to FIG. 7, might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be stored on a computer-readable storage medium, such as the storage device(s) 725 described above. In some cases, the storage medium might be incorporated within a computer system, such as computer system 700. In other embodiments, the storage medium might be separate from a computer system (e.g., a removable medium, such as a compact disc), and/or provided in an installation package, such that the storage medium can be used to program, configure and/or adapt a general purpose computer with the instructions/code stored thereon. These instructions might take the form of executable code, which is executable by the computer system 700 and/or might take the form of source and/or installable code, which, upon compilation and/or installation on the computer system 700 (e.g., using any of a variety of generally available compilers, installation programs, compression/decompression utilities, etc.) then takes the form of executable code.

Substantial variations may be made in accordance with specific requirements. For example, customized hardware might also be used, and/or particular elements might be implemented in hardware, software (including portable software, such as applets, etc.), or both. Further, connection to other computing devices such as network input/output devices may be employed.

Some embodiments may employ a computer system (such as the computer system 700) to perform methods in accordance with the disclosure. For example, some or all of the procedures of the described methods may be performed by the computer system 700 in response to processor 710 executing one or more sequences of one or more instructions (which might be incorporated into the operating system 740 and/or other code, such as an application program 745) contained in the working memory 735. Such instructions may be read into the working memory 735 from another computer-readable medium, such as one or more of the storage device(s) 725. Merely by way of example, execution of the sequences of instructions contained in the working memory 735 might cause the processor(s) 710 to perform one or more procedures of the methods described herein, for example methods described with respect to FIG. 7.

The terms “machine-readable medium” and “computer-readable medium,” as used herein, refer to any medium that participates in providing data that causes a machine to operate in a specific fashion. In an embodiment implemented using the computer system 700, various computer-readable media might be involved in providing instructions/code to processor(s) 710 for execution and/or might be used to store and/or carry such instructions/code (e.g., as signals). In many implementations, a computer-readable medium is a physical and/or tangible storage medium. Such a medium may take many forms, including but not limited to, non-volatile media, volatile media, and transmission media. Non-volatile media include, for example, optical and/or magnetic disks, such as the storage device(s) 725. Volatile media include, without limitation, dynamic memory, such as the working memory 735. Transmission media include, without limitation, coaxial cables, copper wire and fiber optics, including the wires that comprise the bus 705, as well as the various components of the communications subsystem 730 (and/or the media by which the communications subsystem 730 provides communication with other devices). Hence, transmission media can also take the form of waves (including without limitation radio, acoustic and/or light waves, such as those generated during radio-wave and infrared data communications).

Common forms of physical and/or tangible computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, EPROM, a FLASH-EPROM, any other memory chip or cartridge, a carrier wave as described hereinafter, or any other medium from which a computer can read instructions and/or code.

Various forms of computer-readable media may be involved in carrying one or more sequences of one or more instructions to the processor(s) 710 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer system 700. These signals, which might be in the form of electromagnetic signals, acoustic signals, optical signals and/or the like, are all examples of carrier waves on which instructions can be encoded, in accordance with various embodiments of the invention.

The communications subsystem 730 (and/or components thereof) generally will receive the signals, and the bus 705 then might carry the signals (and/or the data, instructions, etc. carried by the signals) to the working memory 735, from which the processor(s) 710 retrieves and executes the instructions. The instructions received by the working memory 735 may optionally be stored on a non-transitory storage device 725 either before or after execution by the processor(s) 710. Memory 735 may contain at least one database according to any of the databases and methods described herein. Memory 735 may thus store any of the values discussed in any of the present disclosures, including FIGS. 1, 2, 3A, 3B, 4, 5A, 5B, 6A, 6B and related descriptions.

The methods described in FIGS. 6A and 6B may be implemented by various blocks in FIG. 7. For example, processor 710 may be configured to perform any of the functions of blocks in flowcharts 600 and 650. Storage device 725 may be configured to store an intermediate result, such as a globally unique attribute or locally unique attribute discussed within any of blocks mentioned herein. Storage device 725 may also contain a database consistent with any of the present disclosures. The memory 735 may similarly be configured to record signals, representation of signals, or database values necessary to perform any of the functions described in any of the blocks mentioned herein. Results that may need to be stored in a temporary or volatile memory, such as RAM, may also be included in memory 735, and may include any intermediate result similar to what may be stored in storage device 725. Input device 715 may be configured to receive wireless signals from satellites and/or base stations according to the present disclosures described herein. Output device 720 may be configured to display images, print text, transmit signals and/or output other data according to any of the present disclosures.

The methods, systems, and devices discussed above are examples. Various embodiments may omit, substitute, or add various procedures or components as appropriate. For instance, in alternative configurations, the methods described may be performed in an order different from that described, and/or various stages may be added, omitted, and/or combined. Also, features described with respect to certain embodiments may be combined in various other embodiments. Different aspects and elements of the embodiments may be combined in a similar manner. Also, technology evolves and, thus, many of the elements are examples that do not limit the scope of the disclosure to those specific examples.

Specific details are given in the description to provide a thorough understanding of the embodiments. However, embodiments may be practiced without these specific details. For example, well-known circuits, processes, algorithms, structures, and techniques have been shown without unnecessary detail in order to avoid obscuring the embodiments. This description provides example embodiments only, and is not intended to limit the scope, applicability, or configuration of the invention. Rather, the preceding description of the embodiments will provide those skilled in the art with an enabling description for implementing embodiments of the invention. Various changes may be made in the function and arrangement of elements without departing from the spirit and scope of the invention.

Also, some embodiments were described as processes depicted as flow diagrams or block diagrams. Although each may describe the operations as a sequential process, many of the operations can be performed in parallel or concurrently. In addition, the order of the operations may be rearranged. A process may have additional steps not included in the figure. Furthermore, embodiments of the methods may be implemented by hardware, software, firmware, middleware, microcode, hardware description languages, or any combination thereof. When implemented in software, firmware, middleware, or microcode, the program code or code segments to perform the associated tasks may be stored in a computer-readable medium such as a storage medium. Processors may perform the associated tasks.

Having described several embodiments, various modifications, alternative constructions, and equivalents may be used without departing from the spirit of the disclosure. For example, the above elements may merely be a component of a larger system, wherein other rules may take precedence over or otherwise modify the application of the invention. Also, a number of steps may be undertaken before, during, or after the above elements are considered. Accordingly, the above description does not limit the scope of the disclosure.

Various examples have been described. These and other examples are within the scope of the following claims.

What is claimed is:

1. A method comprising:
identifying a new floor plan map having a first descriptive metric describing at least one characteristic of the new floor plan map, and the new floor plan map lacking information of a first assistance data parameter associated with the new floor plan map;
identifying a recorded floor plan map having a second descriptive metric describing at least one characteristic of the recorded floor plan map, the second descriptive metric relating to the first descriptive metric of the new floor plan map;
determining a second assistance data parameter associated with the recorded floor plan map with a category that matches a category of the lacking information of the first assistance data parameter associated with the new floor plan map; and
recording information of the first assistance data parameter that was lacking based on information of the second assistance data parameter associated with the recorded floor plan map.

2. The method of claim 1, further comprising:
recording the new floor plan map in a hierarchal relationship tree structure at a position in the hierarchal relationship tree structure based on the first descriptive metric, wherein the hierarchal relationship tree structure comprises a plurality of floor plan maps including the recorded floor plan map, the plurality of floor plan maps organized according to a descriptive metric for each of the plurality of floor plan maps.

3. The method of claim 2, wherein identifying the recorded floor plan map comprises identifying a floor plan map within the plurality of floor plan maps that:
contains information in the category of the lacking information associated with the new floor plan map, and
is determined to be nearest in relationship to the new floor plan map within the hierarchal relationship tree structure.

4. The method of claim 3, wherein determining the nearest relationship to the new floor plan map is based on comparing the first descriptive metric of the new floor plan map with the second descriptive metric of the recorded floor plan map.

5. The method of claim 2, wherein recording the information of the first assistance data parameter that was lacking comprises:
determining an average value among matching assistance data parameters of at least some of the plurality of floor plan maps in the hierarchal relationship tree structure; and
recording the information of the first assistance data parameter to be the average value among the matching assistance data parameters.

6. The method of claim 2, wherein recording the information of the first assistance data parameter that was lacking comprises:
determining a most common value among matching assistance data parameters of at least some of the plurality of floor plan maps in the hierarchal relationship tree structure; and
recording the information of the first assistance data parameter to be the most common value among the matching assistance data parameters.

7. The method of claim 1, wherein the category of the lacking information of the first assistance data parameter comprises at least one of:
a location of an access point, a heatmap signature of an access point, an average thickness of walls on a floor plan map, an average density of walls on a floor plan map, and a geographic location of a floor plan map.

8. The method of claim 1, further comprising:
identifying a third assistance data parameter associated with the new floor plan map having information related to the first assistance data parameter that lacks information; and
recording information of the first assistance data parameter that was lacking based on information of the third assistance data parameter associated with the new floor plan map.

9. An apparatus comprising a processor configured to:
identify a new floor plan map having a first descriptive metric describing at least one characteristic of the new floor plan map, and the new floor plan map lacking information of a first assistance data parameter associated with the new floor plan map;
identify a recorded floor plan map having a second descriptive metric describing at least one characteristic of the recorded floor plan map, the second descriptive metric relating to the first descriptive metric of the new floor plan map;
determine a second assistance data parameter associated with the recorded floor plan map with a category that matches a category of the lacking information of the first assistance data parameter associated with the new floor plan map; and
record information of the first assistance data parameter that was lacking based on information of the second assistance data parameter associated with the recorded floor plan map.

10. The apparatus of claim 9, wherein the processor is further configured to:
record the new floor plan map in a hierarchal relationship tree structure at a position in the hierarchal relationship tree structure based on the first descriptive metric, wherein the hierarchal relationship tree structure comprises a plurality of floor plan maps including the recorded floor plan map, the plurality of floor plan maps organized according to a descriptive metric for each of the plurality of floor plan maps.

11. The apparatus of claim 10, wherein identifying the recorded floor plan map comprises the processor being further configured to identify a floor plan map within the plurality of floor plan maps that:
contains information in the category of the lacking information associated with the new floor plan map, and
is determined to be nearest in relationship to the new floor plan map within the hierarchal relationship tree structure.

12. The apparatus of claim 11, wherein determining the nearest relationship to the new floor plan map is based on the processor being configured to compare the first descriptive metric of the new floor plan map with the second descriptive metric of the recorded floor plan map.

13. The apparatus of claim 10, wherein recording the information of the first assistance data parameter that was lacking comprises the processor being further configured to:
determine an average value among matching assistance data parameters of at least some of the plurality of floor plan maps in the hierarchal relationship tree structure; and
record the information of the first assistance data parameter to be the average value among the matching assistance data parameters.

14. The apparatus of claim 10, wherein recording the information of the first assistance data parameter that was lacking comprises the processor being further configured to:
determine a most common value among matching assistance data parameters of at least some of the plurality of floor plan maps in the hierarchal relationship tree structure; and
record the information of the first assistance data parameter to be the most common value among the matching assistance data parameters.

15. The apparatus of claim 9, wherein the category of the lacking information of the first assistance data parameter comprises at least one of:
a location of an access point, a heatmap signature of an access point, an average thickness of walls on a floor plan map, an average density of walls on a floor plan map, and a geographic location of a floor plan map.

16. The apparatus of claim 9, wherein the processor is further configured to:
identify a third assistance data parameter associated with the new floor plan map having information related to the first assistance data parameter that lacks information; and
record information of the first assistance data parameter that was lacking based on information of the third assistance data parameter associated with the new floor plan map.

17. An apparatus comprising:
means for identifying a new floor plan map having a first descriptive metric describing at least one characteristic of the new floor plan map, and the new floor plan map lacking information of a first assistance data parameter associated with the new floor plan map;
means for identifying a recorded floor plan map having a second descriptive metric describing at least one characteristic of the recorded floor plan map, the second descriptive metric relating to the first descriptive metric of the new floor plan map;
means for determining a second assistance data parameter associated with the recorded floor plan map with a category that matches a category of the lacking information of the first assistance data parameter associated with the new floor plan map; and
means for recording information of the first assistance data parameter that was lacking based on information of the second assistance data parameter associated with the recorded floor plan map.

18. The apparatus of claim 17, further comprising:
means for recording the new floor plan map in a hierarchal relationship tree structure at a position in the hierarchal relationship tree structure based on the first descriptive metric, wherein the hierarchal relationship tree structure comprises a plurality of floor plan maps including the recorded floor plan map, the plurality of floor plan maps organized according to a descriptive metric for each of the plurality of floor plan maps.

19. The apparatus of claim 18, wherein the means for identifying the recorded floor plan map comprises means for identifying a floor plan map within the plurality of floor plan maps that:
contains information in the category of the lacking information associated with the new floor plan map, and
is determined to be nearest in relationship to the new floor plan map within the hierarchal relationship tree structure.

20. The apparatus of claim 19, wherein determining the nearest relationship to the new floor plan map is based on comparing the first descriptive metric of the new floor plan map with the second descriptive metric of the recorded floor plan map.

21. The apparatus of claim 18, wherein the means for recording the information of the first assistance data parameter that was lacking comprises:
means for determining an average value among matching assistance data parameters of at least some of the plurality of floor plan maps in the hierarchal relationship tree structure; and
means for recording the information of the first assistance data parameter to be the average value among the matching assistance data parameters.

22. The apparatus of claim 18, wherein the means for recording the information of the first assistance data parameter that was lacking comprises:
means for determining a most common value among matching assistance data parameters of at least some of the plurality of floor plan maps in the hierarchal relationship tree structure; and
means for recording the information of the first assistance data parameter to be the most common value among the matching assistance data parameters.

23. The apparatus of claim 17, wherein the category of the lacking information of the first assistance data parameter comprises at least one of:
a location of an access point, a heatmap signature of an access point, an average thickness of walls on a floor plan map, an average density of walls on a floor plan map, and a geographic location of a floor plan map.

24. The apparatus of claim 17, further comprising:
means for identifying a third assistance data parameter associated with the new floor plan map having information related to the first assistance data parameter that lacks information; and
means for recording information of the first assistance data parameter that was lacking based on information of the third assistance data parameter associated with the new floor plan map.

25. A computer program product residing on a processor-readable medium and comprising processor-readable instructions configured to cause a processor to:
identify a new floor plan map having a first descriptive metric describing at least one characteristic of the new floor plan map, and the new floor plan map lacking information of a first assistance data parameter associated with the new floor plan map;
identify a recorded floor plan map having a second descriptive metric describing at least one characteristic of the recorded floor plan map, the second descriptive metric relating to the first descriptive metric of the new floor plan map;
determine a second assistance data parameter associated with the recorded floor plan map with a category that matches a category of the lacking information of the first assistance data parameter associated with the new floor plan map; and
record information of the first assistance data parameter that was lacking based on information of the second assistance data parameter associated with the recorded floor plan map.

26. The computer program product of claim 25, wherein the instructions are further configured to cause the processor to:
record the new floor plan map in a hierarchal relationship tree structure at a position in the hierarchal relationship tree structure based on the first descriptive metric, wherein the hierarchal relationship tree structure comprises a plurality of floor plan maps including the recorded floor plan map, the plurality of floor plan maps organized according to a descriptive metric for each of the plurality of floor plan maps.

27. The computer program product of claim 26, wherein identifying the recorded floor plan map comprises instructions further configured to cause the processor to identify a floor plan map within the plurality of floor plan maps that:
contains information in the category of the lacking information associated with the new floor plan map, and
is determined to be nearest in relationship to the new floor plan map within the hierarchal relationship tree structure.

28. The computer program product of claim 27, wherein determining the nearest relationship to the new floor plan map is based on instructions further configured to cause the processor to compare the first descriptive metric of the new floor plan map with the second descriptive metric of the recorded floor plan map.

29. The computer program product of claim 26, wherein recording the information of the first assistance data parameter that was lacking comprises instructions further configured to cause the processor to:
determine an average value among matching assistance data parameters of at least some of the plurality of floor plan maps in the hierarchal relationship tree structure; and
record the information of the first assistance data parameter to be the average value among the matching assistance data parameters.

30. The computer program product of claim 26, wherein recording the information of the first assistance data parameter that was lacking comprises instructions further configured to cause the processor to:
determine a most common value among matching assistance data parameters of at least some of the plurality of floor plan maps in the hierarchal relationship tree structure; and
record the information of the first assistance data parameter to be the most common value among the matching assistance data parameters.

31. The computer program product of claim 25, wherein the category of the lacking information of the first assistance data parameter comprises at least one of:
a location of an access point, a heatmap signature of an access point, an average thickness of walls on a floor plan map, an average density of walls on a floor plan map, and a geographic location of a floor plan map.

32. The computer program product of claim 25, wherein the instructions are further configured to cause the processor to:
identify a third assistance data parameter associated with the new floor plan map having information related to the first assistance data parameter that lacks information; and
record information of the first assistance data parameter that was lacking based on information of the third assistance data parameter associated with the new floor plan map.
